(19) United States
(12) Patent Application Publication
(10) Pub. No.: US 2016/0342233 A1
(43) Pub. Date: Nov. 24, 2016

(54) DISPLAY DEVICE USING SEMICONDUCTOR LIGHT EMITTING DIODE

(71) Applicant: LG ELECTRONICS INC., Seoul (KR)

(72) Inventors: Soobeom LEE, Seoul (KR); Yonghan LEE, Seoul (KR)

(73) Assignee: LG ELECTRONICS INC., Seoul (KR)

(21) Appl. No.: 15/149,516

(22) Filed: May 9, 2016

(30) Foreign Application Priority Data
May 21, 2015 (KR) 10-2015-0071152

(51) Int. Cl. G06F 3/042; G02F 1/1333; G09G 3/36

(52) U.S. Cl. CPC G06F 3/042; G09G 3/3677; G09G 3/3648; G09G 3/3622; G02F 1/13338; G06F 2203/04109; G09G 2310/0202; G06F 2203/04102

(57) ABSTRACT

A display device including a display unit including a plurality of semiconductor light emitting diodes electrically-connected to a plurality of scan lines; a touch sensor including a plurality of sensing regions, and overlapping the plurality of semiconductor light emitting diodes; and a controller configured to sequentially supply a current to a predetermined number of scan lines among the plurality of scan lines, and turn on predetermined semiconductor light emitting diodes electrically-connected to the predetermined number of scan lines, sense a touch input on a second sensing region not overlapped with the turned-on predetermined semiconductor light emitting diodes, and not sense the touch input on a first sensing region overlapped with the turned-on predetermined semiconductor light emitting diodes.

### CROSS-REFERENCE TO RELATED APPLICATION

Pursuant to 35 U.S.C. §119(a), this application claims the benefit of earlier filing date and right of priority to Korean Application No. 10-2015-0071152, filed on May 21, 2015, the contents of which is incorporated by reference herein in its entirety.

### BACKGROUND OF THE INVENTION

1. Field of the Invention

The present invention relates to a display device, and more particularly, to a display device using a semiconductor light emitting diode.

2. Background of the Invention

In recent years, display devices having excellent characteristics such as low profile, flexibility and the like have been developed in the display technical field. On the contrary, currently commercialized main displays are represented by liquid crystal displays (LCDs) and active matrix organic light emitting diodes (AMOLEDs). However, there exist problems such as slow response time, difficult implementation of flexibility in LCDs, and there exist drawbacks such as short life span, poor yield as well as low flexibility in AMOLEDs.

Further, light emitting diodes (LEDs) are well known light emitting devices for converting an electrical current to light, and have been used as a light source for displaying an image in an electronic device including information communication devices since red LEDs using GaAsP compound semiconductors were made commercially available in 1962, together with a GaP:N-based green LEDs. Accordingly, the semiconductor light emitting devices may be used to implement a flexible display, thereby presenting a scheme for solving the problems.

In such a display device, it is important to develop a thin film display technique due to an emphasized slim characteristic. Further, it is important to develop a touch screen controllable using a finger, a pen, etc. on a display screen. Generally, a touch screen is driven as a display driving time and a touch driving time are separately configured. In this instance, during the display driving time, a touch circuit is not driven because a touch input may not be precisely recognized as noise generated from a display panel is introduced into a touch sensor. During the touch driving time, a display is not driven for touch recognition. However, for a time-division method, a light emitting time is reduced within a unitary frame and a maximum brightness of the display is reduced, since the display does not emit light during the touch driving time.

### SUMMARY OF THE INVENTION

Therefore, an aspect of the detailed description is to provide a display device driven in a novel manner differentiated from a time-division driving method where a display panel and a touch sensor are separately driven at different time points.

Another aspect of the detailed description is to provide a touch sensor driving method which does not influence on brightness of a display panel.

To achieve these and other advantages and in accordance with the purpose of this specification, as embodied and broadly described herein, there is provided a display device, including: a display unit including a plurality of semiconductor light emitting diodes disposed to be electrically-connected to a plurality of scan lines; a touch sensor including a plurality of sensing regions, and disposed to be overlapped with the plurality of semiconductor light emitting diodes; and a controller configured to sense a touch input using the touch sensor, and to drive the display unit by controlling current supply to the plurality of scan lines, wherein the controller sequentially supplies a current to the scan lines, and turns on semiconductor light emitting diodes electrically-connected to the current-supplied scan line, wherein the sensing of the touch input is not performed on a sensing region corresponding to the plurality of turned-on semiconductor light emitting diodes, among the plurality of sensing regions, and wherein the sensing of the touch input is performed on a sensing region not overlapped with the plurality of turned-on semiconductor light emitting diodes, among the plurality of sensing regions.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a conceptual view illustrating a display device using a semiconductor light emitting diode according to an embodiment of the present disclosure;

FIG. 2 is a partial enlarged view of portion “A” in FIG. 1;

FIGS. 3A and 3B are cross-sectional views taken along lines B-B and C-C in FIG. 2;

FIG. 4 is a conceptual view illustrating a flip-chip type semiconductor light emitting diode in FIG. 3A;

FIGS. 5A through 5C are conceptual views illustrating various forms for implementing colors in connection with a flip-chip type semiconductor light emitting diode;

FIG. 6 is cross-sectional views illustrating a method of fabricating a display device using a semiconductor light emitting diode according to the present disclosure;

FIG. 7 is a perspective view illustrating a display device using a semiconductor light emitting diode according to another embodiment of the present disclosure;

FIG. 8 is a cross-sectional view taken along line C-C in FIG. 7;

FIG. 9 is a conceptual view illustrating a vertical type semiconductor light emitting diode in FIG. 8;

FIGS. 10 and 11 are conceptual views illustrating an example of a display device having a touch sensor;

FIGS. 12A and 12B are conceptual views illustrating a plurality of touch sensor regions in a display device according to an embodiment of the present invention; and

FIGS. 13 and 14 are conceptual views illustrating a touch sensor driving method in a display device according to an embodiment of the present invention.

### DETAILED DESCRIPTION OF THE INVENTION

Hereinafter, the embodiments disclosed herein will be described in detail with reference to the accompanying drawings, and the same or similar elements are designated with the same numeral references regardless of the numerals in the drawings and their redundant description will be omitted. A suffix “module” or “unit” used for constituent elements disclosed in the following description is merely intended for easy description of the specification, and the suffix itself does not give any special meaning or function. Also, it should be noted that the accompanying drawings are merely illustrated to easily explain the concept of the invention, and therefore, they should not be construed to limit the technological concept disclosed herein by the accompanying drawings. Furthermore, when an element such as a layer, region or substrate is referred to as being “on” another element, it can be directly on the other element or an intermediate element may also be interposed therebetween.

A display device disclosed herein may include a portable phone, a smart phone, a laptop computer, a digital broadcast terminal, a personal digital assistant (PDA), a portable multimedia player (PMP), a navigation, a slate PC, a tablet PC, an ultrabook, a digital TV, a desktop computer, and the like. However, it would be easily understood by those skilled in the art that a configuration disclosed herein may be applicable to any displayable device even though it is a new product type which will be developed later.

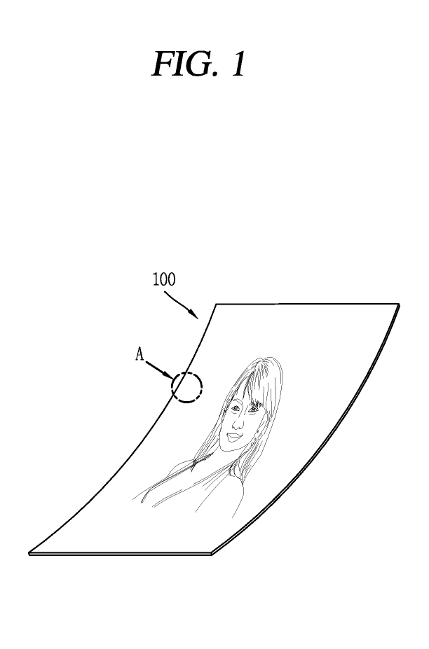

FIG. 1 is a conceptual view illustrating a display device using a semiconductor light emitting device according to an embodiment of the present disclosure. According to the drawing, information processed in the controller of the display device 100 can be displayed using a flexible display.

The flexible display may include a flexible, bendable, twistable, foldable and rollable display. For example, the flexible display may be a display fabricated on a thin and flexible substrate that can be warped, bent, folded or rolled like a paper sheet while maintaining the display characteristics of a flat display in the related art.

A display area of the flexible display becomes a plane in a configuration that the flexible display is not warped (for example, a configuration having an infinite radius of curvature, hereinafter, referred to as a “first configuration”). The display area thereof becomes a curved surface in a configuration that the flexible display is warped by an external force in the first configuration (for example, a configuration having a finite radius of curvature, hereinafter, referred to as a “second configuration”). As illustrated in the drawing, information displayed in the second configuration may be visual information displayed on a curved surface. The visual information may be implemented by individually controlling the light emission of sub-pixels disposed in a matrix form. The sub-pixel denotes a minimum unit for implementing one color.

The sub-pixel of the flexible display may be implemented by a semiconductor light emitting device. According to the present disclosure, a light emitting diode (LED) is illustrated as a type of semiconductor light emitting device. The light emitting diode may be formed with a small size to perform the role of a sub-pixel even in the second configuration through this.

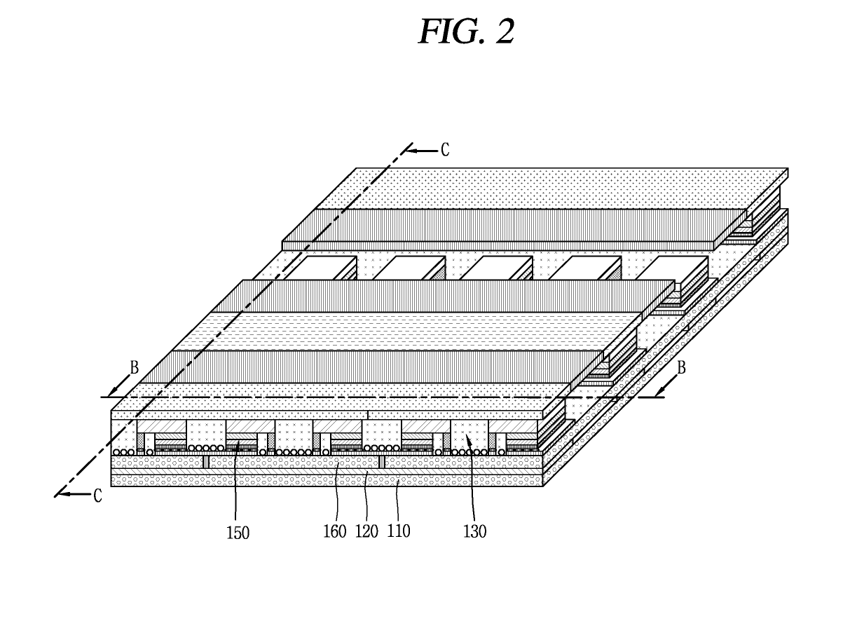

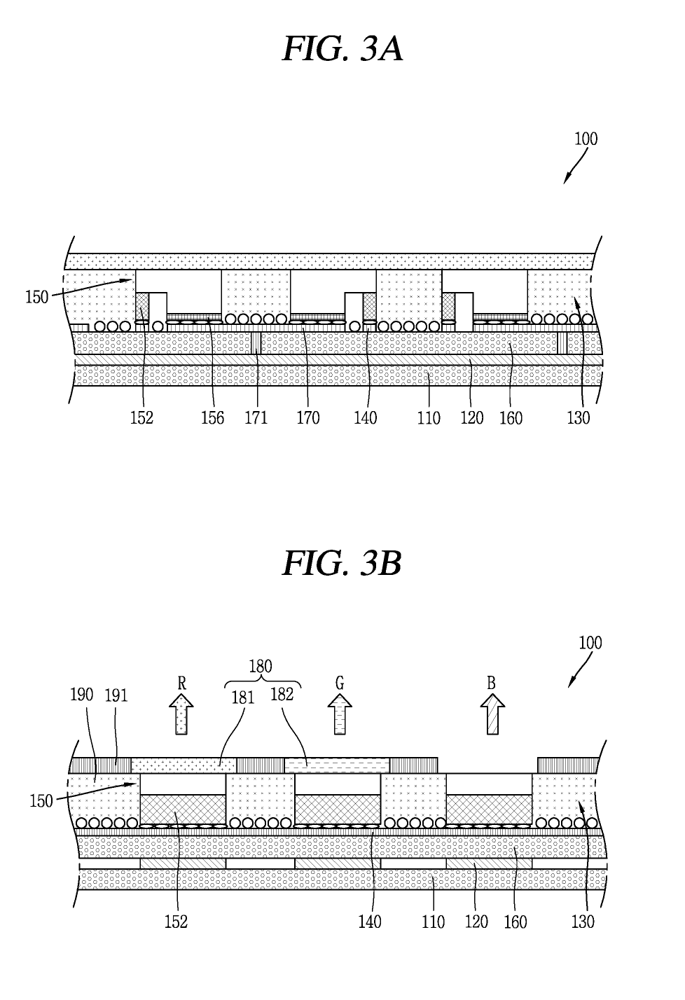

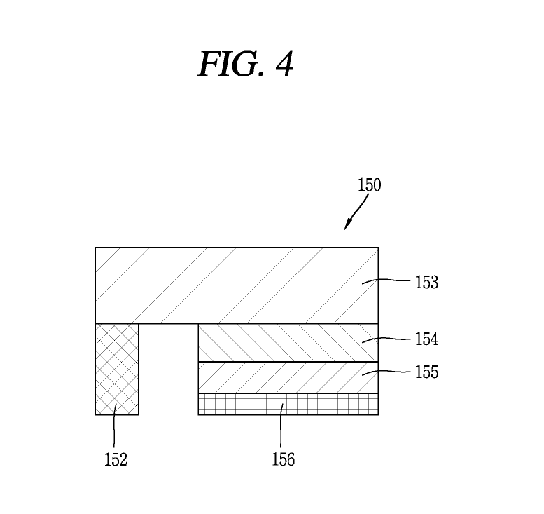

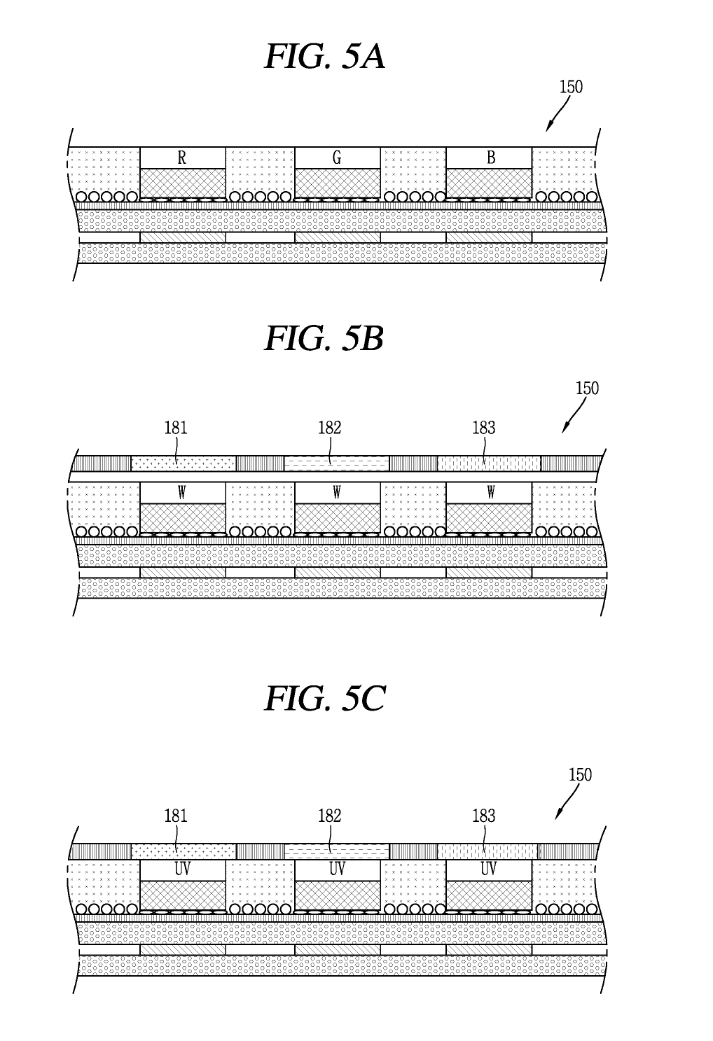

Hereinafter, a flexible display implemented using the light emitting diode will be described in more detail with reference to the accompanying drawings. In particular, FIG. 2 is a partial enlarged view of portion “A” in FIG. 1, and FIGS. 3A and 3B are cross-sectional views taken along lines B-B and C-C in FIG. 2, FIG. 4 is a conceptual view illustrating a flip-chip type semiconductor light emitting device in FIG. 3A, and FIGS. 5A through 5C are conceptual views illustrating various forms for implementing colors in connection with a flip-chip type semiconductor light emitting device.

FIGS. 2, 3A and 3B illustrate a display device 100 using a passive matrix (PM) type semiconductor light emitting device as a display device 100 using a semiconductor light emitting device. However, the following illustration is also applicable to an active matrix (AM) type semiconductor light emitting device.

As shown, the display device 100 includes a substrate 110, a first electrode 120, a conductive adhesive layer 130, a second electrode 140, and a plurality of semiconductor light emitting devices 150. The substrate 110 may be a flexible substrate. The substrate 110 may contain glass or polyimide (PI) to implement the flexible display device.

In addition, if it is a flexible material, any one such as polyethylene naphthalate (PEN), polyethylene terephthalate (PET) or the like may be used. Furthermore, the substrate 110 may be either one of transparent and non-transparent materials. The substrate 110 may be a wiring substrate disposed with the first electrode 120, and thus the first electrode 120 may be placed on the substrate 110.

According to the drawing, an insulating layer 160 may be disposed on the substrate 110 placed with the first electrode 120, and an auxiliary electrode 170 may be placed on the insulating layer 160. In this instance, a configuration in which the insulating layer 160 is deposited on the substrate 110 may be single wiring substrate. More specifically, the insulating layer 160 may be incorporated into the substrate 110 with an insulating and flexible material such as polyimide (PI), PET, PEN or the like to form single wiring substrate.

The auxiliary electrode 170 as an electrode for electrically connecting the first electrode 120 to the semiconductor light emitting device 150 is placed on the insulating layer 160, and disposed to correspond to the location of the first electrode 120. For example, the auxiliary electrode 170 has a dot shape, and may be electrically connected to the first electrode 120 by an electrode hole 171 passing through the insulating layer 160. The electrode hole 171 may be formed by filling a conductive material in a hole.

Referring to the drawings, the conductive adhesive layer 130 may be formed on one surface of the insulating layer 160, but the present disclosure is not limited to this. For example, the conductive adhesive layer 130 can be disposed on the substrate 110 with no insulating layer 160. The conductive adhesive layer 130 thus performs the role of an insulating layer in the structure in which the conductive adhesive layer 130 is disposed on the substrate 110.

Further conductive adhesive layer 130 may be a layer having adhesiveness and conductivity, and a conductive material and an adhesive material may be mixed on the conductive adhesive layer 130. Furthermore, the conductive adhesive layer 130 may have flexibility, thereby allowing a flexible function in the display device.

For example, the conductive adhesive layer 130 may be an anisotropic conductive film (ACF), an anisotropic conductive paste, a solution containing conductive particles, and the like. The conductive adhesive layer 130 may allow electrical interconnection in the z-direction passing through the thickness thereof, but may be configured as a layer having electrical insulation in the horizontal x-y direction thereof. Accordingly, the conductive adhesive layer 130 may be referred to as a z-axis conductive layer (however, hereinafter referred to as a “conductive adhesive layer”).

The anisotropic conductive film is a film with a form in which an anisotropic conductive medium is mixed with an insulating base member, and thus when heat and pressure are applied thereto, only a specific portion thereof may have conductivity by means of the anisotropic conductive medium. Hereinafter, heat and pressure are applied to the anisotropic conductive film, but other methods may be also available for the anisotropic conductive film to partially have conductivity. The methods may include applying only either one of heat and pressure thereto, UV curing, and the like.

Furthermore, the anisotropic conductive medium may be conductive balls or particles. According to the drawing, in the present embodiment, the anisotropic conductive film is a film with a form in which an anisotropic conductive medium is mixed with an insulating base member, and thus when heat and pressure are applied thereto, only a specific portion thereof has conductivity by the conductive balls. The anisotropic conductive film may include a core with a conductive material containing a plurality of particles coated by an insulating layer with a polymer material, and in this instance, have conductivity by the core while breaking an insulating layer on a portion to which heat and pressure are applied. Here, a core may be transformed to implement a layer having both surfaces to which objects contact in the thickness direction of the film.

In a more specific example, heat and pressure are applied to an anisotropic conductive film as a whole, and electrical connection in the z-axis direction is partially formed by a height difference from a mating object adhered by the use of the anisotropic conductive film. In another example, an anisotropic conductive film may include a plurality of particles in which a conductive material is coated on insulating cores. In this instance, a portion to which heat and pressure are applied are converted (pressed and adhered) to a conductive material to have conductivity in the thickness direction of the film. In still another example, it may be formed to have conductivity in the thickness direction of the film in which a conductive material passes through an insulating base member in the z-direction. In this instance, the conductive material can have a pointed end portion.

According to the drawing, the anisotropic conductive film may be a fixed array anisotropic conductive film (ACF) configured with a form in which conductive balls are inserted into one surface of the insulating base member. More specifically, the insulating base member is formed of an adhesive material, and the conductive balls are intensively disposed at a bottom portion of the insulating base member, and when heat and pressure are applied thereto, the base member is modified along with the conductive balls, thereby having conductivity in the vertical direction thereof.

However, the present disclosure is not limited to this, and the anisotropic conductive film can have a form in which conductive balls are randomly mixed with an insulating base member or a form configured with a plurality of layers in which conductive balls are disposed at any one layer (double-ACF), and the like.

The anisotropic conductive paste as a form coupled to a paste and conductive balls may be a paste in which conductive balls are mixed with an insulating and adhesive base material. Furthermore, a solution containing conductive particles may be a solution in a form containing conductive particles or nano particles.

Referring to the drawing again, the second electrode 140 is located at the insulating layer 160 to be separated from the auxiliary electrode 170. In other words, the conductive adhesive layer 130 is disposed on the insulating layer 160 located with the auxiliary electrode 170 and second electrode 140.

When the conductive adhesive layer 130 is formed in a state that the auxiliary electrode 170 and second electrode 140 are located, and then the semiconductor light emitting device 150 is connect thereto in a flip chip form with the application of heat and pressure, the semiconductor light emitting device 150 is electrically connected to the first electrode 120 and second electrode 140.

Referring to FIG. 4, the semiconductor light emitting device 150 can be a flip chip type semiconductor light emitting device. For example, the semiconductor light emitting device may include a p-type electrode 156, a p-type semiconductor layer 155 formed with the p-type electrode 156, an active layer 154 formed on the p-type semiconductor layer 155, an n-type semiconductor layer 153 formed on the active layer 154, and an n-type electrode 152 disposed to be separated from the p-type electrode 156 in the horizontal direction on the n-type semiconductor layer 153. In this instance, the p-type electrode 156 may be electrically connected to the welding portion 179 by the conductive adhesive layer 130, and the n-type electrode 152 may be electrically connected to the second electrode 140.

Referring to FIGS. 2, 3A and 3B again, the auxiliary electrode 170 can be formed in an elongated manner in one direction to be electrically connected to a plurality of semiconductor light emitting devices 150. For example, the left and right p-type electrodes of the semiconductor light emitting devices around the auxiliary electrode may be electrically connected to one auxiliary electrode.

More specifically, the semiconductor light emitting device 150 is pressed into the conductive adhesive layer 130, and through this, only a portion between the p-type electrode 156 and auxiliary electrode 170 of the semiconductor light emitting device 150 and a portion between the n-type electrode 152 and second electrode 140 of the semiconductor light emitting device 150 have conductivity, and the remaining portion does not have conductivity since there is no push-down of the semiconductor light emitting device. Furthermore, a plurality of semiconductor light emitting devices 150 constitutes a light-emitting array, and a phosphor layer 180 is formed on the light-emitting array.

The light emitting device may include a plurality of semiconductor light emitting devices with different self luminance values. Each of the semiconductor light emitting devices 150 constitutes a sub-pixel, and is electrically connected to the first electrode 120. For example, there may exist a plurality of first electrodes 120, and the semiconductor light emitting devices are arranged in several rows, for instance, and each row of the semiconductor light emitting devices may be electrically connected to any one of the plurality of first electrodes.

Furthermore, the semiconductor light emitting devices may be connected in a flip chip form, and thus semiconductor light emitting devices grown on a transparent dielectric substrate. Furthermore, the semiconductor light emitting devices may be nitride semiconductor light emitting devices, for instance. The semiconductor light emitting device 150 has an excellent luminance characteristic, and thus it is possible to configure individual sub-pixels even with a small size thereof.

According to the drawing, a partition wall 190 may be formed between the semiconductor light emitting devices 150. In this instance, the partition wall 190 divides individual sub-pixels from one another, and can be formed as an integral body with the conductive adhesive layer 130. For example, a base member of the anisotropic conductive film can form the partition wall when the semiconductor light emitting device 150 is inserted into the anisotropic conductive film.

Furthermore, when the base member of the anisotropic conductive film is black, the partition wall 190 has reflective characteristics while at the same time increasing contrast with no additional black insulator. In another example, a reflective partition wall can be separately provided with the partition wall 190. In this instance, the partition wall 190 may include a black or white insulator according to the purpose of the display device. It may have an effect of enhancing reflectivity when the partition wall of the while insulator is used, and increase contrast while at the same time having reflective characteristics.

The phosphor layer 180 can be located at an outer surface of the semiconductor light emitting device 150. For example, the semiconductor light emitting device 150 is a blue semiconductor light emitting device that emits blue (B) light, and the phosphor layer 180 performs the role of converting the blue (B) light into the color of a sub-pixel. The phosphor layer 180 may be a red phosphor layer 181 or green phosphor layer 182 constituting individual pixels.

In other words, a red phosphor 181 capable of converting blue light into red (R) light may be deposited on the blue semiconductor light emitting device 151 at a location implementing a red sub-pixel, and a green phosphor 182 capable of converting blue light into green (G) light may be deposited on the blue semiconductor light emitting device 151 at a location implementing a green sub-pixel. Furthermore, only the blue semiconductor light emitting device 151 may be solely used at a location implementing a blue sub-pixel. In this instance, the red (R), green (G) and blue (B) sub-pixels may implement one pixel. More specifically, one color phosphor may be deposited along each line of the first electrode 120. Accordingly, one line on the first electrode 120 may be an electrode controlling one color. In other words, red (R), green (B) and blue (B) may be sequentially disposed, thereby implementing sub-pixels.

However, the present disclosure is not limited to this, and the semiconductor light emitting device 150 may be combined with a quantum dot (QD) instead of a phosphor to implement sub-pixels such as red (R), green (G) and blue (B). Furthermore, a black matrix 191 may be disposed between each phosphor layer to enhance contrast. In other words, the black matrix 191 can enhance the contrast of luminance. However, the present disclosure is not limited to this, and another structure for implementing blue, red and green may be also applicable thereto.

Referring to FIG. 5A, each of the semiconductor light emitting devices 150 may be implemented with a high-power light emitting device that emits various lights including blue in which gallium nitride (GaN) is mostly used, and indium (In) and or aluminum (Al) are added thereto. In this instance, the semiconductor light emitting device 150 may be red, green and blue semiconductor light emitting devices, respectively, to implement each sub-pixel. For instance, red, green and blue semiconductor light emitting devices (R, G, B) are alternately disposed, and red, green and blue sub-pixels implement one pixel by the red, green and blue semiconductor light emitting devices, thereby implementing a full color display.

Referring to FIG. 5B, the semiconductor light emitting device 150 may have a white light emitting device (W) provided with a yellow phosphor layer for each element. In this instance, a red phosphor layer 181, a green phosphor layer 182 and blue phosphor layer 183 may be provided on the white light emitting device (W) to implement a sub-pixel. Furthermore, a color filter repeated with red, green and blue on the white light emitting device (W) may be used to implement a sub-pixel.

Referring to FIG. 5C, a red phosphor layer 181, a green phosphor layer 182 and blue phosphor layer 183 can be provided on a ultra violet light emitting device (UV). Thus, the semiconductor light emitting device 150 can be used over the entire region up to ultra violet (UV) as well as visible light, and may be extended to a form of semiconductor light emitting device in which ultra violet (UV) can be used as an excitation source.

Taking the present example into consideration again, the semiconductor light emitting device 150 is placed on the conductive adhesive layer 130 to configure a sub-pixel in the display device. The semiconductor light emitting device 150 has excellent luminance characteristics, and thus it is possible to configure individual sub-pixels even with a small size thereof. The size of the individual semiconductor light emitting device 150 can be less than 80 μm in the length of one side thereof, and formed with a rectangular or square shaped element. For a rectangular shaped element, the size thereof can be less than 20×80 μm.

Furthermore, even when a square shaped semiconductor light emitting device 150 with a length of side of 10 μm is used for a sub-pixel, it will exhibit a sufficient brightness for implementing a display device. Accordingly, for example, for a rectangular pixel in which one side of a sub-pixel is 600 μm in size, and the remaining one side thereof is 300 μm, a relative distance between the semiconductor light emitting devices becomes sufficiently large. Accordingly, in this instance, it is possible to implement a flexible display device having a HD image quality.

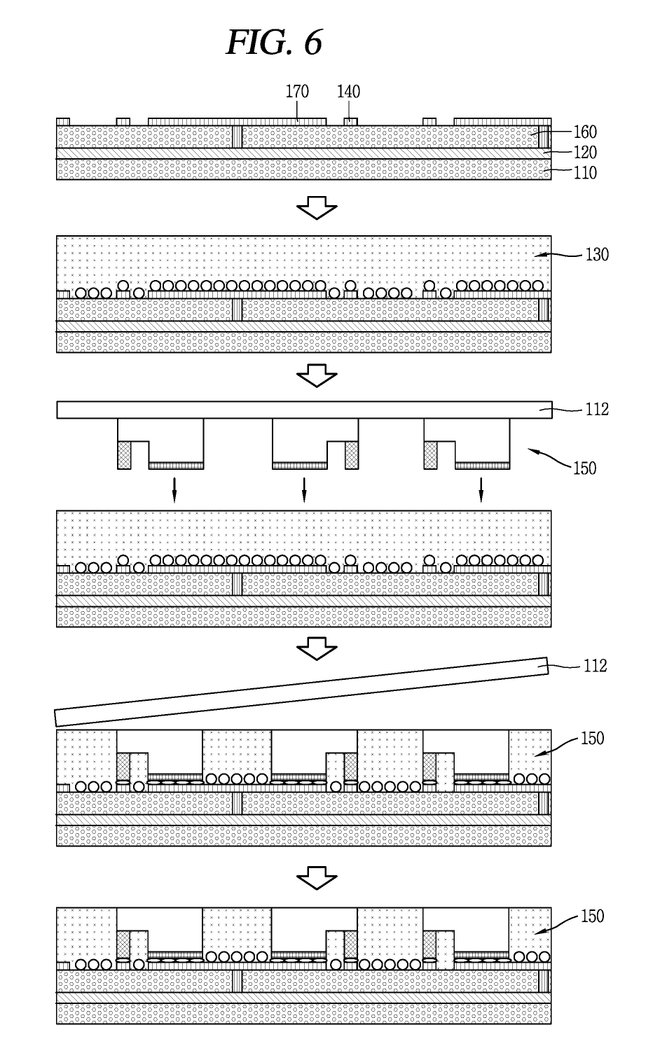

A display device using the foregoing semiconductor light emitting device will be fabricated by a new type of fabrication method. Hereinafter, the fabrication method will be described with reference to FIG. 6. In particular, FIG. 6 includes cross-sectional views illustrating a method of fabricating a display device using a semiconductor light emitting device according to the present disclosure.

Referring to the drawing, first, the conductive adhesive layer 130 is formed on the insulating layer 160 located with the auxiliary electrode 170 and second electrode 140. The insulating layer 160 is deposited on the first substrate 110 to form one substrate (or wiring substrate), and the first electrode 120, auxiliary electrode 170 and second electrode 140 are disposed at the wiring substrate. In this instance, the first electrode 120 and second electrode 140 may be disposed in a perpendicular direction to each other. Furthermore, the first substrate 110 and insulating layer 160 may contain glass or polyimide (PI), respectively, to implement a flexible display device.

The conductive adhesive layer 130 may be implemented by an anisotropic conductive film, for example, and an anisotropic conductive film may be coated on a substrate located with the insulating layer 160. Next, a second substrate 112 located with a plurality of semiconductor light emitting devices 150 corresponding to the location of the auxiliary electrodes 170 and second electrodes 140 and constituting individual pixels is disposed such that the semiconductor light emitting device 150 faces the auxiliary electrode 170 and second electrode 140.

In this instance, the second substrate 112 as a growth substrate for growing the semiconductor light emitting device 150 may be a sapphire substrate or silicon substrate. The semiconductor light emitting device may have a gap and size capable of implementing a display device when formed in the unit of wafer, and thus effectively used for a display device.

Next, the wiring substrate is thermally compressed to the second substrate 112. For example, the wiring substrate and second substrate 112 may be thermally compressed to each other by applying an ACF press head. The wiring substrate and second substrate 112 are bonded to each other using the thermal compression. Only a portion between the semiconductor light emitting device 150 and the auxiliary electrode 170 and second electrode 140 may have conductivity due to the characteristics of an anisotropic conductive film having conductivity by thermal compression, thereby allowing the electrodes and semiconductor light emitting device 150 to be electrically connected to each other. At this time, the semiconductor light emitting device 150 may be inserted into the anisotropic conductive film, thereby forming a partition wall between the semiconductor light emitting devices 150.

Next, the second substrate 112 is removed. For example, the second substrate 112 may be removed using a laser lift-off (LLO) or chemical lift-off (CLO) method. Finally, the second substrate 112 is removed to expose the semiconductor light emitting devices 150 to the outside. Silicon oxide (SiOx) or the like may be coated on the wiring substrate coupled to the semiconductor light emitting device 150 to form a transparent insulating layer.

Furthermore, it may further include the process of forming a phosphor layer on one surface of the semiconductor light emitting device 150. For example, the semiconductor light emitting device 150 may be a blue semiconductor light emitting device for emitting blue (B) light, and red or green phosphor for converting the blue (B) light into the color of the sub-pixel may form a layer on one surface of the blue semiconductor light emitting device.

The fabrication method or structure of a display device using the foregoing semiconductor light emitting device may be modified in various forms. For example, the foregoing display device may be applicable to a vertical semiconductor light emitting device. Hereinafter, the vertical structure will be described with reference to FIGS. 5 and 6. Furthermore, according to the following modified example or embodiment, the same or similar reference numerals are designated to the same or similar configurations to the foregoing example, and the description thereof will be substituted by the earlier description.

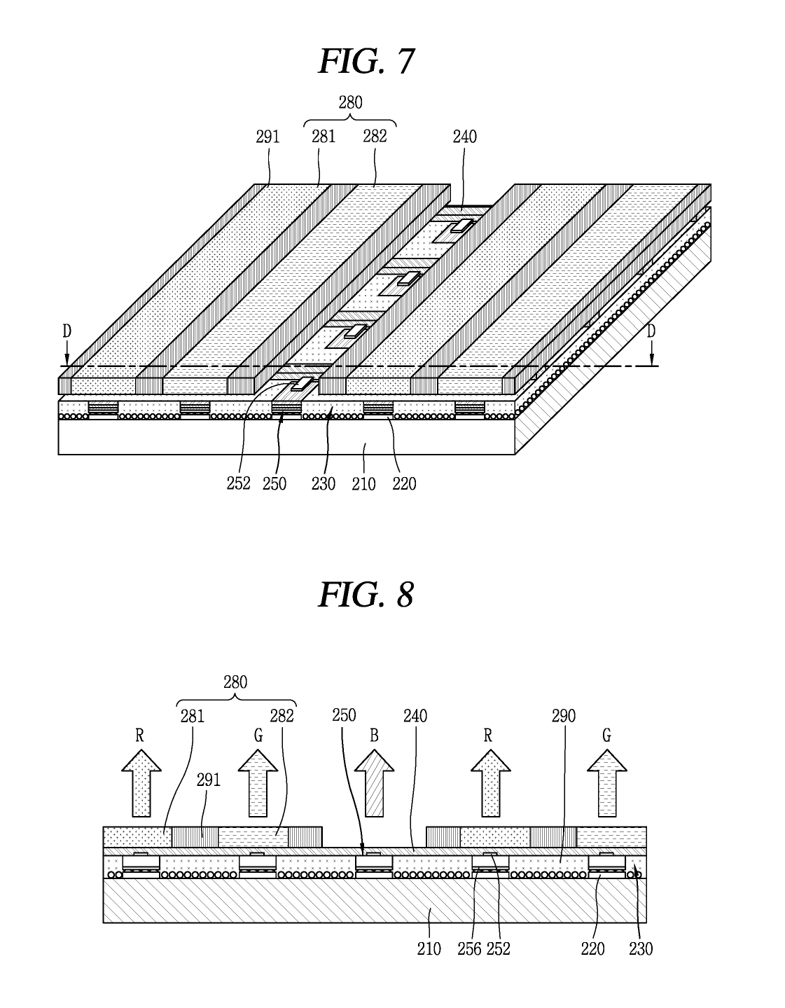

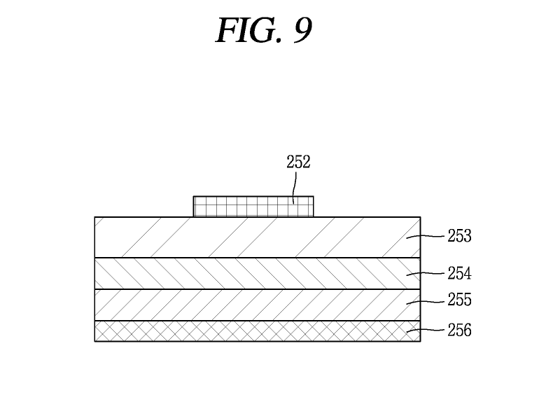

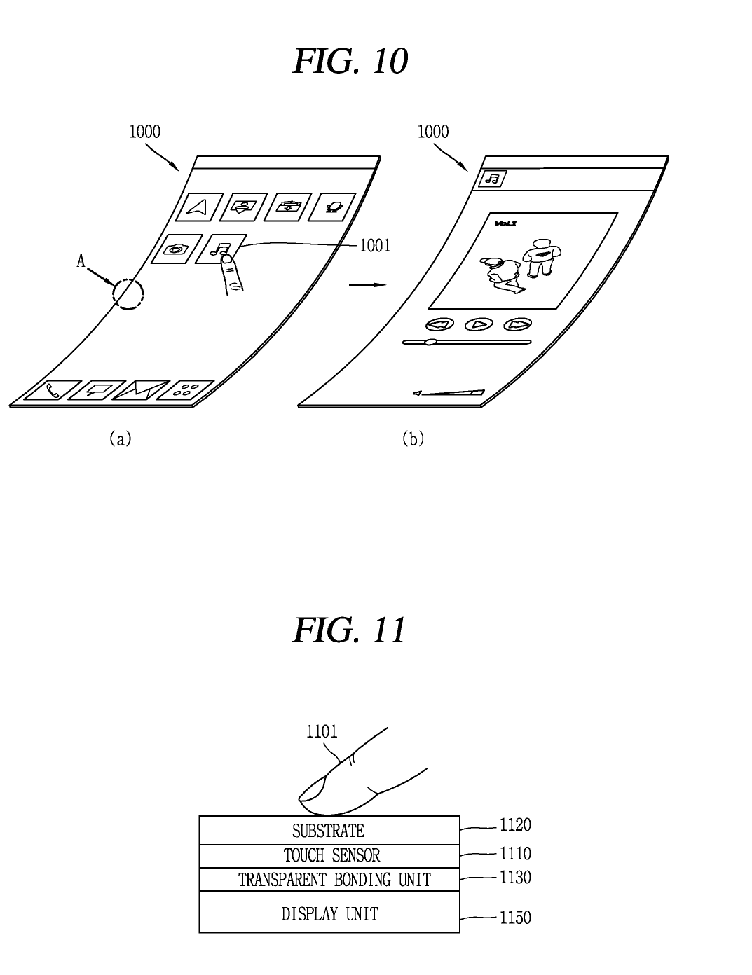

FIG. 7 is a perspective view illustrating a display device using a semiconductor light emitting device according to another embodiment of the present disclosure, and FIG. 8 is a cross-sectional view taken along line C-C in FIG. 7, and FIG. 9 is a conceptual view illustrating a vertical type semiconductor light emitting device in FIG. 8. According to the drawings, the display device is using a passive matrix (PM) type of vertical semiconductor light emitting device.

The display device may include a substrate 210, a first electrode 220, a conductive adhesive layer 230, a second electrode 240 and a plurality of semiconductor light emitting devices 250. The substrate 210 as a wiring substrate disposed with the first electrode 220 may include polyimide (PI) to implement a flexible display device. In addition, any one may be used if it is an insulating and flexible material.

The first electrode 220 may be located on the substrate 210, and formed with an electrode having a bar elongated in one direction. The first electrode 220 may be formed to perform the role of a data electrode. The conductive adhesive layer 230 is formed on the substrate 210 located with the first electrode 220. Similarly to a display device to which a flip chip type light emitting device is applied, the conductive adhesive layer 230 may be an anisotropic conductive film (ACF), an anisotropic conductive paste, a solution containing conductive particles, and the like. However, the present embodiment illustrates when the conductive adhesive layer 230 is implemented by an anisotropic conductive film.

When an anisotropic conductive film is located when the first electrode 220 is located on the substrate 210, and then heat and pressure are applied to connect the semiconductor light emitting device 250 thereto, the semiconductor light emitting device 250 is electrically connected to the first electrode 220. At this time, the semiconductor light emitting device 250 may be preferably disposed on the first electrode 220.

The electrical connection is generated because an anisotropic conductive film partially has conductivity in the thickness direction when heat and pressure are applied as described above. Accordingly, the anisotropic conductive film is partitioned into a portion 231 having conductivity and a portion 232 having no conductivity in the thickness direction thereof. Furthermore, the anisotropic conductive film contains an adhesive component, and thus the conductive adhesive layer 230 implements a mechanical coupling as well as an electrical coupling between the semiconductor light emitting device 250 and the first electrode 220.

Thus, the semiconductor light emitting device 250 is placed on the conductive adhesive layer 230, thereby configuring a separate sub-pixel in the display device. The semiconductor light emitting device 250 has excellent luminance characteristics, and thus it is possible to configure individual sub-pixels even with a small size thereof. The size of the individual semiconductor light emitting device 250 may be less than 80 μm in the length of one side thereof, and formed with a rectangular or square shaped element. For a rectangular shaped element, the size thereof may be less than 20×80 μm.

The semiconductor light emitting device 250 may be a vertical structure. A plurality of second electrodes 240 disposed in a direction crossed with the length direction of the first electrode 220, and electrically connected to the vertical semiconductor light emitting device 250 may be located between vertical semiconductor light emitting devices.

Referring to FIG. 9, the vertical semiconductor light emitting device includes a p-type electrode 256, a p-type semiconductor layer 255 formed with the p-type electrode 256, an active layer 254 formed on the p-type semiconductor layer 255, an n-type semiconductor layer 253 formed on the active layer 254, and an n-type electrode 252 formed on the n-type semiconductor layer 253. In this instance, the p-type electrode 256 located at the bottom thereof may be electrically connected to the first electrode 220 by the conductive adhesive layer 230, and the n-type electrode 252 located at the top thereof may be electrically connected to the second electrode 240 which will be described later. The electrodes may be disposed in the upward/downward direction in the vertical semiconductor light emitting device 250, thereby providing a great advantage capable of reducing the chip size.

Referring to FIG. 8 again, a phosphor layer 280 may be formed on one surface of the semiconductor light emitting device 250. For example, the semiconductor light emitting device 250 is a blue semiconductor light emitting device 251 that emits blue (B) light, and the phosphor layer 280 for converting the blue (B) light into the color of the sub-pixel may be provided thereon. In this instance, the phosphor layer 280 may be a red phosphor 281 and a green phosphor 282 constituting individual pixels.

In other words, a red phosphor 281 capable of converting blue light into red (R) light may be deposited on the blue semiconductor light emitting device 251 at a location implementing a red sub-pixel, and a green phosphor 282 capable of converting blue light into green (G) light may be deposited on the blue semiconductor light emitting device 251 at a location implementing a green sub-pixel. Furthermore, only the blue semiconductor light emitting device 251 may be solely used at a location implementing a blue sub-pixel. In this instance, the red (R), green (G) and blue (B) sub-pixels may implement one pixel. However, the present disclosure is not limited to this, and another structure for implementing blue, red and green may be also applicable thereto as described above in a display device to which a flip chip type light emitting device is applied.

Taking the present embodiment into consideration again, the second electrode 240 is located between the semiconductor light emitting devices 250, and electrically connected to the semiconductor light emitting devices 250. For example, the semiconductor light emitting devices 250 may be disposed in a plurality of rows, and the second electrode 240 may be located between the rows of the semiconductor light emitting devices 250.

Since a distance between the semiconductor light emitting devices 250 constituting individual pixels is sufficiently large, the second electrode 240 may be located between the semiconductor light emitting devices 250. The second electrode 240 may be formed with an electrode having a bar elongated in one direction, and disposed in a perpendicular direction to the first electrode.

Furthermore, the second electrode 240 may be electrically connected to the semiconductor light emitting device 250 by a connecting electrode protruded from the second electrode 240. More specifically, the connecting electrode may be an n-type electrode of the semiconductor light emitting device 250. For example, the n-type electrode is formed with an ohmic electrode for ohmic contact, and the second electrode covers at least part of the ohmic electrode by printing or deposition. Through this, the second electrode 240 may be electrically connected to the n-type electrode of the semiconductor light emitting device 250.

According to the drawing, the second electrode 240 may be located on the conductive adhesive layer 230. According to circumstances, a transparent insulating layer containing silicon oxide (SiOx) may be formed on the substrate 210 formed with the semiconductor light emitting device 250. When the transparent insulating layer is formed and then the second electrode 240 is placed thereon, the second electrode 240 may be located on the transparent insulating layer. Furthermore, the second electrode 240 may be formed to be separated from the conductive adhesive layer 230 or transparent insulating layer.

If a transparent electrode such as indium tin oxide (ITO) is used to locate the second electrode 240 on the semiconductor light emitting device 250, the ITO material has a problem of bad adhesiveness with an n-type semiconductor. Accordingly, the second electrode 240 may be placed between the semiconductor light emitting devices 250, thereby obtaining an advantage in which the transparent electrode is not required. Accordingly, an n-type semiconductor layer and a conductive material having a good adhesiveness may be used as a horizontal electrode without being restricted by the selection of a transparent material, thereby enhancing the light extraction efficiency.

According to the drawing, a partition wall 290 may be formed between the semiconductor light emitting devices 250. In other words, the partition wall 290 may be disposed between the vertical semiconductor light emitting devices 250 to isolate the semiconductor light emitting device 250 constituting individual pixels. In this instance, the partition wall 290 may perform the role of dividing individual sub-pixels from one another, and be formed as an integral body with the conductive adhesive layer 230. For example, a base member of the anisotropic conductive film may form the partition wall when the semiconductor light emitting device 250 is inserted into the anisotropic conductive film.

Furthermore, when the base member of the anisotropic conductive film is black, the partition wall 290 may have reflective characteristics while at the same time increasing contrast with no additional black insulator. In another example, a reflective partition wall may be separately provided with the partition wall 290. In this instance, the partition wall 290 may include a black or white insulator according to the purpose of the display device.

If the second electrode 240 is precisely located on the conductive adhesive layer 230 between the semiconductor light emitting devices 250, the partition wall 290 may be located between the semiconductor light emitting device 250 and second electrode 240. Accordingly, individual sub-pixels may be configured even with a small size using the semiconductor light emitting device 250, and a distance between the semiconductor light emitting devices 250 may be relatively sufficiently large to place the second electrode 240 between the semiconductor light emitting devices 250, thereby having the effect of implementing a flexible display device having a HD image quality.

Furthermore, according to the drawing, a black matrix 291 may be disposed between each phosphor layer to enhance contrast. In other words, the black matrix 291 can enhance the contrast of luminance. As described above, the semiconductor light emitting device 250 is located on the conductive adhesive layer 230, thereby constituting individual pixels on the display device. Since the semiconductor light emitting device 250 has excellent luminance characteristics, thereby configuring individual sub-pixels even with a small size thereof. As a result, it is possible to implement a full color display in which the sub-pixels of red (R), green (G) and blue (B) implement one pixel by the semiconductor light emitting device.

The aforementioned display device may be further provided with a touch sensor for sensing a touch operation applied to the display device. The display device having the touch sensor includes a display unit (or a display module) and a touch sensor, and may be used as an input device as well as an output device.

The touch sensor can sense a touch input applied to the display device, using at least one of a plurality of touch methods including a resistive film method, a capacitive method, an infrared ray method, an ultrasonic wave method, a magnetic field method, etc. Hereinafter, a structure of a display device having a touch sensor for sensing a touch input in a capacitive manner will be explained in more detail. However, the touch sensor of the present invention is not limited to the capacitive type. For instance, the touch sensor of the present invention may adopt a magnetic field method that a touch sensor is provided with a single magnetic field coil, etc.

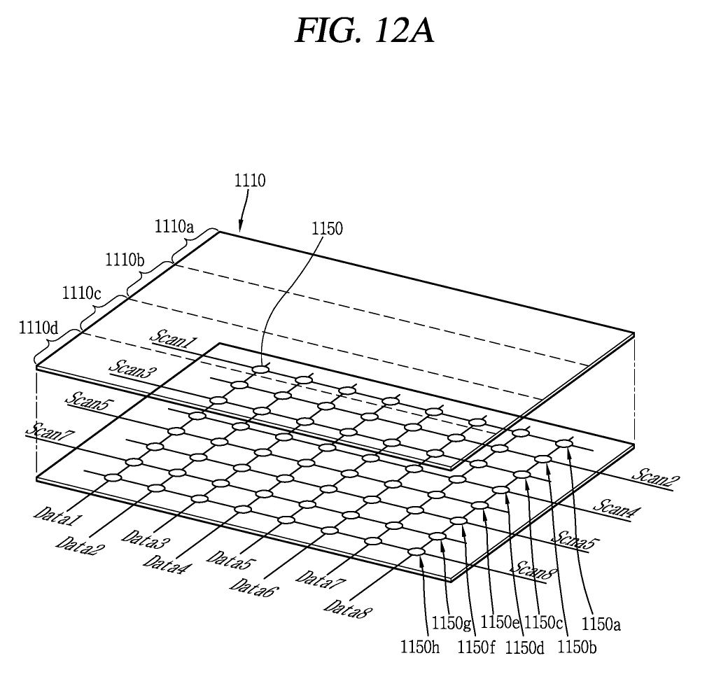

The touch sensor for sensing a touch input in a capacitive manner may be configured to convert pressure applied to a specific part, or a change such as a capacitance (electrostatic capacity) occurring from a specific part of a display module, into an electric input signal. If a touch input is sensed by the touch sensor, signals corresponding to the touch input may be processed by the controller of the display device. Then, the processed signals may be converted into corresponding data. Hereinafter, the display device having such a capacitive method will be explained in more detail with reference to the attached drawings. FIGS. 10 and 11 are conceptual views illustrating an example of a display device having a touch sensor.

Referring to FIG. 10, information processed by the controller of the display device 1000 may be displayed by using a flexible display. Explanations about the flexible display will be replaced by those executed with reference to FIG. 1. As shown, the display device 1000 configured as a flexible display may be provided with a touch sensor. For instance, as shown in FIG. 10(a), once a touch input is applied to the display device 1000, the controller can process the touch input, and execute a control corresponding to the processed touch input.

For instance, if a touch input is applied to an arbitrary icon 1001 as shown in FIG. 10(a), the controller can process the touch input, and output screen information corresponding to the touch input to the display device 1000, as shown in FIG. 10(b). In this instance, the touch input may be applied in a bent state of the flexible display, and the touch sensor is configured to sense the touch input applied in the bent state of the flexible display.

Unit pixels of the display device 1000 configured as a flexible display may be implemented by semiconductor light emitting devices. In an embodiment of the present invention, the semiconductor light emitting devices for converting a current into light is implemented as light emitting diodes (LEDs). The light emitting diode is formed to have a small size, by which it can serve as a unit pixel even in the second state.

The aforementioned display device having its front surface and rear surface touchable will be explained schematically with reference to FIG. 11. The display device 1000 according to an embodiment of the present invention includes a substrate 1120, a touch sensor 1110, a transparent bonding unit 1130 and a display unit 1150.

As explained with reference to FIG. 2, the display unit 1150 includes a plurality of semiconductor light emitting diodes which implement unit pixels. The touch sensor 1110 is formed to be overlapped with the display unit 1150. The touch sensor 1110 may be overlapped with the display unit 1150, when the transparent bonding unit 1130 is interposed therebetween. The touch sensor 1110 is disposed on either one side or another side of the plurality of semiconductor light emitting diodes, and is configured to sense a touch input applied to the display unit 1150. That is, the touch sensor 1110 may be disposed on one of one surface and another surface of the display unit 1150. The substrate 1120 formed of a reinforcing glass or a polyimide material, may be disposed on the touch sensor 1110.

In an embodiment of the present invention, the display unit 1150 is formed of semiconductor light emitting diodes, thereby implementing a thin film display having a very small thickness. The touch sensor 1110 of the present invention has a thin structure and is formed of a thin material, considering a thickness of the display unit. For instance, the touch sensor 1110 may be formed of touch electrodes having a capacitive touch and disposed on a substrate formed of a reinforcing glass or a polyimide material.

In order to implement a thinnest touch screen suitable for the flexible display, the touch electrode may have a single layer. Further, the touch sensor 1110 may be bonded to the display unit 1150 by the transparent bonding unit 1130. With such a configuration, a flexible touch screen of the present invention may be implemented.

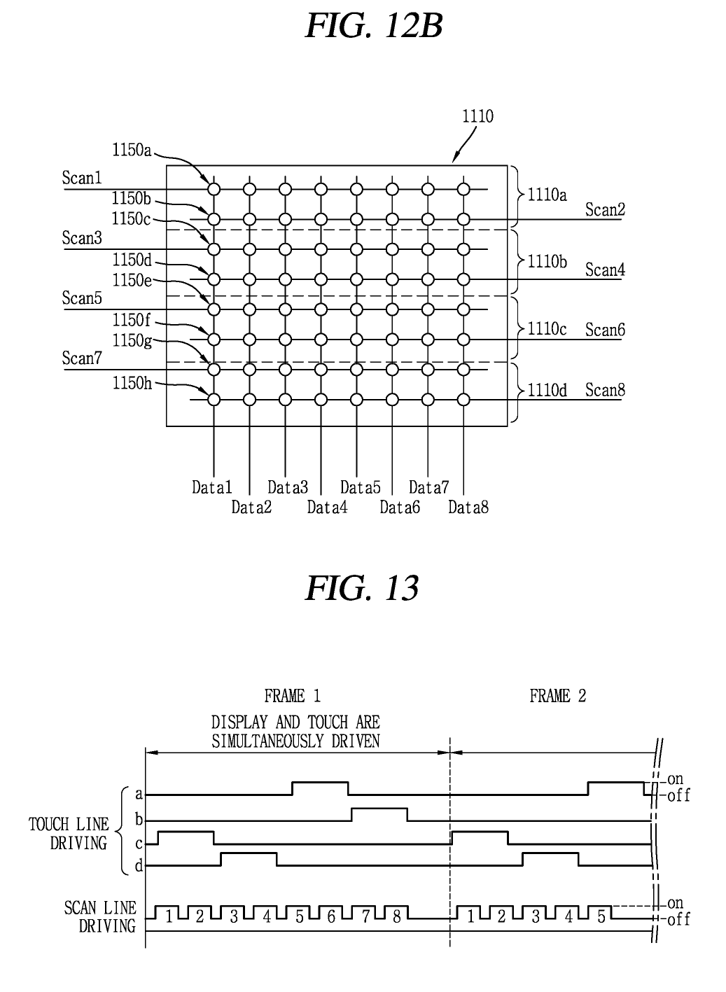

Hereinafter, a flexible display having a touch sensor and implemented by using the light emitting diodes will be explained in more detail with reference to the drawings. In particular, FIGS. 12A and 12B are conceptual views illustrating a plurality of touch sensor regions in the display device according to an embodiment of the present invention.

Before explaining FIGS. 12A and 12B, the structure of the aforementioned display device 1000 will be mentioned. In the display device according to an embodiment of the present invention, the semiconductor light emitting diodes are electrically-connected to first electrodes 120, 220 and second electrodes 140, 240 (refer to FIGS. 2, 3A, 7 and 8). In this instance, the first electrodes 120, 220 may be data lines for transmitting data driving signals, and the second electrodes 140, 240 may be scan lines for transmitting scan driving signals.

As aforementioned, a single line of data lines may be an electrode for controlling a single color. That is, semiconductor light emitting diodes or phosphors may be disposed such that a red color, a green color and a blue color (RGB) are sequentially implemented along a single scan line. With such a configuration, unit pixels may be implemented. In the display device of an embodiment of the present invention, a plurality of scan lines and a plurality of data lines are provided, and a plurality of semiconductor light emitting diodes are arranged a long each scan line.

The display device of the present invention may be driven in unit of each frame. That is, the controller can drive the display unit 1150 and the touch sensor 1110 in unit of each frame. More specifically, the controller can sequentially supply a current to scan lines provided at the display device. Thus, the semiconductor light emitting diodes disposed to correspond to the scan lines can be sequentially turned on along the scan lines, as a current is sequentially supplied to the scan lines. If a current is not supplied to the data lines under control of the controller, even if a current is sequentially supplied to the scan lines, the semiconductor light emitting diodes corresponding to the data lines to which no current has been supplied, are not turned on. This is obvious to those skilled in the art, and thus its detailed explanations will be omitted.

In the display device of an embodiment of the present invention, the touch sensor 1100 can be driven in unit of each frame where a current is sequentially supplied to scan lines, for sensing of a touch input applied to the display device. That is, in the display device of an embodiment of the present invention, the display unit 1150 and the touch sensor 1110 are driven in unit of each frame. In explaining a driving method of the display unit 1150 and the touch sensor 1110, it is assumed that the display device is provided with 8 scan lines (scan 1 scan 8) and 8 data lines (data 1˜data 8) as shown in FIGS. 12A and 12B, for convenience.

As shown, the display unit 1150 includes a plurality of semiconductor light emitting diodes electrically-connected to a plurality of scan lines. The plurality of semiconductor light emitting diodes form a plurality of semiconductor light emitting arrays along the scan lines. For instance, as shown, a plurality of semiconductor light emitting diode arrays 1150a, 1150b, 1150c, 1150d, 1150e, 1150f, 1150g, 1150h are formed along a plurality of scan lines (scan 1˜scan 8). The plurality of semiconductor light emitting diode arrays 1150a, 1150b, 1150c, 1150d, 1150e, 1150f, 1150g, 1150h are sequentially turned on in unit of arrays, as a current is sequentially supplied to the plurality of scan lines (scan 1˜scan 8).

As shown, the touch sensor 1110 is disposed to be overlapped with the semiconductor light emitting diodes provided at the display unit 1150. The touch sensor 1110 may include a plurality of sensing regions 1110a, 1110b, 1110c, 1110d. Boundaries among the plurality of sensing regions 1110a, 1110b, 1110c, 1110d may be formed in parallel to the scan lines.

The plurality of sensing regions 1110a, 1110b, 1110c, 1110d are overlapped with at least part of the plurality of semiconductor light emitting diode arrays 1150a, 1150b, 1150c, 1150d, 1150e, 1150f, 1150g, 1150h disposed in correspondence to the plurality of scan lines (scan 1˜scan 8). For instance, referring to FIGS. 12A and 12B, the first sensing region 1110a may be overlapped with the first and second semiconductor light emitting diode arrays 1150a, 1150b disposed to correspond to the first and second scan lines (scan 1, scan 2). In addition, the second sensing region 1110b may be overlapped with the third and fourth semiconductor light emitting diode arrays 1150c, 1150d disposed to correspond to the third and fourth scan lines (scan 3, scan 4). Further, the third sensing region 1110c may be overlapped with the fifth and sixth semiconductor light emitting diode arrays 1150e, 1150f disposed to correspond to the fifth and sixth scan lines (scan 5, scan 6). Also, the fourth sensing region 1110d may be overlapped with the seventh and eighth semiconductor light emitting diode arrays 1150g, 1150h disposed to correspond to the seventh and eighth scan lines (scan 7, scan 8).

In the display device according to an embodiment of the present invention, the display unit 1150 and the touch sensor 1110 can be simultaneously driven. That is, in order to turn on the display unit 1150, the controller sequentially supplies a current to the plurality of scan lines (scan 1˜scan 8), and process a touch to at least one of the plurality of sensing regions 1110a, 1110b, 1110c, 1110d included in the touch sensor 1110.

The plurality of sensing regions may be formed to cover the plurality of scan lines, and each sensing region may be formed to cover at least two scan lines. The number of scan lines covered by each sensing region may be variable according to a resolution of the display unit. The number of scan lines covered by each sensing region may be several hundred or several thousand according to a resolution of the display unit. In the display device according to an embodiment of the present invention, it is possible to determine the number of divided sensing regions of the touch sensor according to a resolution of the display unit. When the touch sensor is divided into a large number of sensing regions, a touch driving time may be prolonged. Therefore, it is preferable to divide the touch sensor into a proper number of sensing regions, considering the touch driving time.

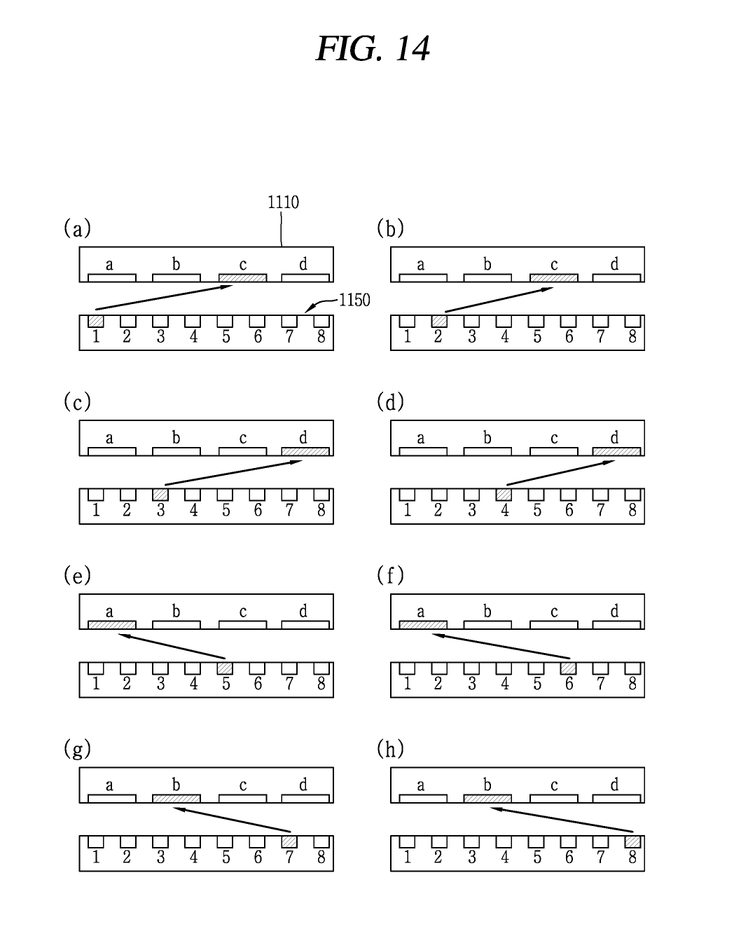

Hereinafter, a driving method of the display unit and the touch sensor of the display device according to an embodiment of the present invention will be explained in more detail with reference to the attached drawings. In particular, FIGS. 13 and 14 are conceptual views illustrating a touch sensor driving method in a display device according to an embodiment of the present invention.

In the display device according to an embodiment of the present invention, the controller can sequentially supply a current to a plurality of scan lines per frame, thereby turning on semiconductor light emitting diodes included in a semiconductor light emitting diode array disposed to correspond to each scan line. The controller can process a touch input applied to at least one sensing region rather than a sensing region overlapped with a semiconductor light emitting diode array disposed to correspond to a scan line to which a current is being supplied.

More specifically, a touch input is not sensed on a sensing region corresponding to a plurality of turned-on semiconductor light emitting diodes, among the plurality of sensing regions. That is, a touch input is sensed on a sensing region corresponding to a plurality of turned-off semiconductor light emitting diodes, among the plurality of sensing regions.

A touch input applied to a sensing region overlapped with a semiconductor light emitting diode array disposed to correspond to a current-supplied scan line, is not precisely sensed due to noise by a turned-on state of semiconductor light emitting diodes. Thus, in an embodiment of the present invention, a touch input is sensed on a sensing region not overlapped with a semiconductor light emitting diode array including a currently turned-on semiconductor light emitting diode. This prevents inaccurate touch sensing due to noise by a turned-on state of semiconductor light emitting diodes.

Further, the touch sensor 1110 may be formed to have at least 4 sensing regions. That is, the touch sensor 1110 can be divided into at least 4 regions. In this instance, a touch input can be sensed on a sensing region not adjacent to a sensing region overlapped with a semiconductor light emitting diode array including a currently turned-on semiconductor light emitting diode.

Since a touch input is sensed on a sensing region spaced from a sensing region overlapped with a semiconductor light emitting diode array including a currently turned-on semiconductor light emitting diode, noise due to a turned-on state of semiconductor light emitting diodes is reduced.

Thus, a touch input can be sensed on a sensing region not adjacent to a sensing region corresponding to a plurality of turned-on semiconductor light emitting diodes, among sensing regions corresponding to a plurality of turned-off semiconductor light emitting diodes. As the touch sensor 1110 is divided into a plurality of regions, the display unit 1150 can be also divided into a plurality of regions. For instance, if the touch sensor 1110 is divided into 4 regions, the display unit 1150 can be also divided into 4 regions. Boundaries among regions included in the display unit 1150 correspond to boundaries among regions of the touch sensor 1110. For instance, a first region of the touch sensor 1110 may be overlapped with a first region of the display unit 1150.

As the display unit 1150 is divided into a plurality of regions, scan lines included in the display unit 1150 can be also divided into a plurality of groups. For instance, scan lines corresponding to a first region of the display unit 1150 can form a first group, and scan lines corresponding to a second region of the display unit 1150 can form a second group. Thus, the first group of scan lines can be disposed to correspond to a first sensing region, and the second group of scan lines can be disposed to correspond to a second sensing region. That is, each group of scan lines can be overlapped with each sensing region of the touch sensor 1110 overlapped with the display unit 1150.

In this instance, while the scan lines corresponding to the first group are turned on, a touch input applied to a sensing region corresponding to the first group (e.g., a first sensing region) among the plurality of sensing regions, is not processed. Thus, in an embodiment of the present invention, ‘processing a touch input’ means that a contact by a touch object 1101 (refer to FIG. 11) onto a corresponding sensing region is processed as a touch input. On the contrary, ‘not processing a touch input’ means that there is no change in capacitance even if there is a contact by the touch object 1101, because a corresponding sensing region is turned off. Alternatively, ‘not processing a touch input’ may mean that a change in capacitance due to a contact by the touch object 1101 is not processed as a touch input under control of the controller, even if a corresponding sensing region is turned on.

More specifically, the controller turns on semiconductor light emitting diodes electrically-connected to a current-supplied scan line, and senses a touch input on a region except for a region adjacent to the plurality of turned-on semiconductor light emitting diodes, among the plurality of sensing regions. That is, the controller can sense a touch input on at least one sensing region except for a sensing region overlapped with semiconductor light emitting diodes electrically-connected to the current-supplied scan line, among the plurality of sensing regions.

That is, a touch input is not sensed on a sensing region corresponding to the plurality of turned-on semiconductor light emitting diodes, among the plurality of sensing regions. Rather, a touch input can be sensed on a sensing region corresponding to a plurality of turned-off semiconductor light emitting diodes, among the plurality of sensing regions. For instance, while the semiconductor light emitting diodes electrically-connected to the current-supplied scan line are turned on, the controller can turn off a touch sensor included in a sensing region overlapped with the semiconductor light emitting diodes electrically-connected to the current-supplied scan line.

For instance, as shown in FIGS. 12A, 12B and 13, while a current is supplied to the first and second scan lines, the controller can turn off the first sensing region 1110a overlapped with the first and second scan lines (or overlapped with the first and second semiconductor light emitting arrays 1150a, 1150b corresponding to the first and second scan lines). In this instance, even if a touch input is applied to the first sensing region 1110a, the controller does not recognize the touch input.

Further, while a current is supplied to the first and second scan lines (scan 1, scan 2), the controller can turn on at least one sensing region except for the first sensing region 1110a, among the plurality of sensing regions 1110a, 1110b, 1110c, 1110d. Thus, inaccurate touch sensing due to noise generated from the first sensing region 1110a is prevented when semiconductor light emitting diodes corresponding to the first and second semiconductor light emitting arrays 1150a, 1150b are turned on, as a current is supplied to the first and second scan lines (scan 1, scan 2).

The touch sensor 1110 can also be formed to have at least 4 sensing regions. When the touch sensor 1110 is divided into at least 4 sensing regions, a touch input can be sensed on a region not adjacent to a sensing region overlapped with a semiconductor light emitting diode array including a currently turned-on semiconductor light emitting diode. In this instance, since a touch input is sensed on a sensing region spaced from a sensing region overlapped with a semiconductor light emitting diode array including a currently turned-on semiconductor light emitting diode, noise due to a turned-on state of semiconductor light emitting diodes is reduced.

Boundaries among regions included in the display unit 1150 may correspond to boundaries among regions of the touch sensor 1110. For instance, a first region of the touch sensor 1110 may be overlapped with a first region of the display unit 1150. As the display unit 1150 is divided into a plurality of regions, scan lines included in the display unit 1150 may be also divided into a plurality of groups. For instance, scan lines corresponding to a first region of the display unit 1150 may form a first group, and scan lines corresponding to a second region of the display unit 1150 may form a second group. Thus, the first group of scan lines can be disposed to correspond to a first sensing region, and the second group of scan lines can be disposed to correspond to a second sensing region. That is, each group of scan lines can be overlapped with each sensing region of the touch sensor 1110 overlapped with the display unit 1150.

In this instance, while the scan lines corresponding to the first group are turned on, a touch input applied to a sensing region corresponding to the first group (e.g., a first sensing region) among the plurality of sensing regions, is not processed. Thus, in an embodiment of the present invention, while the scan lines corresponding to the first group are turned on, a touch input applied to a sensing region not adjacent to the first sensing region corresponding to the first group, can be processed.

For instance, as shown in FIG. 13, while the first and second scan lines (first group) are turned on, the controller can turn on at least one sensing region except for the first sensing region 1110a overlapped with the first and second scan lines (or overlapped with the semiconductor light emitting arrays corresponding to the first and second scan lines) (e.g., the third sensing region 1110c, refer to touch line driving signal ‘c’ of FIG. 13). Thus, the controller can sense a touch input applied to the display unit 1150.

The first sensing region 1110a overlapped with the first and second scan lines can be turned on while a current is supplied to scan lines (scan 3˜scan 8) different from the first and second scan lines (scan 1, scan 2, first group). In this instance, the first sensing region 1110a may be continuously or instantaneously turned on while a current is supplied to the scan lines (scan 3˜scan 8) different from the first and second scan lines (scan 1, scan 2, first group).

That is, the controller can turn on a touch sensor included in a sensing region overlapped with a current-supplied scan line, at a time point when a current is not supplied to the scan line corresponding to the overlapped sensing region. As shown, while the third and fourth scan lines (second group) are turned on, the controller can turn on at least one sensing region except for the second sensing region 1110b overlapped with the third and fourth scan lines (or overlapped with the semiconductor light emitting arrays corresponding to the third and fourth scan lines) (e.g., the fourth sensing region 1110d, refer to touch line driving signal ‘d’ of FIG. 13). Thus, the controller can sense a touch input applied to the display unit 1150.

As shown, while the fifth and sixth scan lines (third group) are turned on, the controller can turn on at least one sensing region except for the third sensing region 1110c overlapped with the fifth and sixth scan lines (or overlapped with the semiconductor light emitting arrays corresponding to the fifth and sixth scan lines) (e.g., the first sensing region 1110a, refer to touch line driving signal ‘a’ of FIG. 13). Thus, the controller can sense a touch input applied to the display unit 1150.

In an embodiment of the present invention, the controller can turn on a sensing region spaced from a sensing region overlapped with a turned-on scan line. Thus, the controller can control the display device such that a touch input is sensed on a region except for a sensing region overlapped with a turned-on scan line.

As aforementioned, in the display device according to an embodiment of the present invention, a touch input is sensed on a region not adjacent to a sensing region overlapped with a group of turned-on scan lines. When the touch sensor 1110 is divided into 4 regions, a touch input sensing region may have the same spacing distance regardless of its position. Thus, if a touch input is sensed on a region not overlapped with a group of turned-on scan lines, noise is reduced.

As aforementioned, the controller can sequentially supply a current to the scan lines in unit of each frame, and turn on semiconductor light emitting diodes electrically-connected to the current-supplied first scan line. In addition, the controller can turn on a touch sensor included in a first sensing region overlapped with the plurality of turned-on semiconductor light emitting diodes, among the plurality of sensing regions 1110a, 1110b, 1110c, 1110d, at a time point when a current is not supplied to the first scan line.

If semiconductor light emitting diodes electrically-connected to another scan line different from the first scan line are turned on, as current supply to the first scan line is stopped and a current is supplied to said another scan line within the frame, the controller can turn on the touch sensor included in the first sensing region overlapped with the semiconductor light emitting diodes electrically-connected to the current supply-disrupted first scan line. In this instance, a touch sensor included in a sensing region overlapped with a plurality of semiconductor light emitting diodes electrically-connected to said another scan line may be turned off while the plurality of semiconductor light emitting diodes electrically-connected to said another scan line are turned on.

In the display device according to an embodiment of the present invention, a sensing region overlapped with a scan line to which a current is being supplied may be turned off. Alternatively, a touch input applied to the sensing region overlapped with the scan line to which a current is being supplied may not be processed. In the latter case, even if the sensing region overlapped with the scan line to which a current is being supplied is turned on, a contact onto the sensing region is not processed as a touch input, while a current is being supplied to the scan line corresponding to the sensing region.

In the display device according to an embodiment of the present invention, touch sensors included in a plurality of sensing regions are sequentially turned on in unit of each sensing region. In this instance, the turned-on sensing region corresponds to a region spaced from a sensing region overlapped with a current-supplied scan line.

As shown in FIGS. 14(a) and 14(b), while a current is supplied to the first and second scan lines (scan 1, scan 2), a touch input can be sensed on the third sensing region 1110c spaced from the first sensing region 1110a overlapped with the first and second scan lines (scan 1, scan 2). As shown in FIGS. 14(c) and 14(d), while a current is supplied to the third and fourth scan lines (scan 3, scan 4), a touch input can be sensed on the fourth sensing region 1110d spaced from the second sensing region 1110b overlapped with the third and fourth scan lines (scan 3, scan 4). As shown in FIGS. 14(e) and 14(f), while a current is supplied to the fifth and sixth scan lines (scan 5, scan 6), a touch input can be sensed on the first sensing region 1110a spaced from the third sensing region 1110c overlapped with the fifth and sixth scan lines (scan 5, scan 6). As shown in FIGS. 14(g) and 14(h), while a current is supplied to the seventh and eighth scan lines (scan 7, scan 8), a touch input may be sensed on the second sensing region 1110b spaced from the fourth sensing region 1110d overlapped with the seventh and eighth scan lines (scan 7, scan 8).

The display device according to an embodiment of the present invention has the following advantages. Firstly, since a touch input is sensed by a touch sensor corresponding to a region spaced from turned-on semiconductor light emitting diodes, a malfunction of the touch sensor due to noise generated by the turned-on semiconductor light emitting diodes can be prevented.

Further, as aforementioned, since a display panel is always turned on within a unitary frame, the visibility and the brightness of the display panel are enhanced. That is, in the display device according to an embodiment of the present invention, the display panel can maintain a turned-on state for a longer time than the related art display panel, because a touch driving time is not provided separately within a unitary frame. This allows the brightness and visibility to be enhanced, than in the related art display driving method.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A display device, comprising:
a display unit including a plurality of semiconductor light emitting diodes electrically-connected to a plurality of scan lines;
a touch sensor including a plurality of sensing regions, and overlapping the plurality of semiconductor light emitting diodes; and
a controller configured to:
sequentially supply a current to a predetermined number of scan lines among the plurality of scan lines, and turn on predetermined semiconductor light emitting diodes electrically-connected to the predetermined number of scan lines,
sense a touch input on a second sensing region not overlapped with the turned-on predetermined semiconductor light emitting diodes, and
not sense the touch input on a first sensing region overlapped with the turned-on predetermined semiconductor light emitting diodes.

2. The display device of claim 1, wherein the controller is further configured to turn off the touch sensor included in the first sensing region.

3. The display device of claim 2, wherein the controller is further configured to turn on the touch sensor included in the first sensing region when the predetermined semiconductor light emitting diodes are turned off.

4. The display device of claim 1, wherein the touch input is applied to at least one sensing region different from the first sensing region.

5. The display device of claim 4, wherein the controller is further configured not to process the touch input by a touch object onto the first sensing region, while the predetermined semiconductor light emitting diodes are turned on.

6. The display device of claim 1, wherein the first sensing region overlaps first and second scan lines, the second sensing region overlaps third and fourth scan lines, a third sensing region overlaps fifth and sixth scan lines, and a fourth sensing region overlaps seventh and eight scan lines.

7. The display device of claim 6, wherein the controller is further configured to sense the touch input on the second sensing region when the current is applied to the first or second scan lines.

8. The display device of claim 6, wherein the controller is further configured to sense the touch input on the fourth sensing region when the current is applied to the third or fourth scan lines.

9. The display device of claim 6, wherein the controller is further configured to sense the touch input on the first sensing region when the current is applied to the fifth or sixth scan lines.

10. The display device of claim 6, wherein the controller is further configured to sense the touch input on the second sensing region when the current is applied to the seventh or eighth scan lines.

11. The display device of claim 1, further comprising:
data lines crossing the plurality of scan lines.

12. The display device of claim 6, wherein the controller is further configured to turn off the first sensing region, the second sensing region, and the fourth sensing region and turn on the third sensing region while the current is supplied to the first and second scan lines.

13. The display device of claim 12, wherein the controller is further configured to turn off the first sensing region, the second sensing region, and the third sensing region and turn on the fourth sensing region while the current is supplied to the third and fourth scan lines.

14. The display device of claim 13, wherein the controller is further configured to turn off the second sensing region, the third sensing region, and the fourth sensing region and turn on the first sensing region while the current is supplied to the fifth and sixth scan lines.

15. The display device of claim 14, wherein the controller is further configured to turn off the first sensing region, the third sensing region, and the fourth sensing region and turn on the second sensing region while the current is supplied to the seventh and eight scan lines.

16. The display device of claim 1, wherein the plurality of scan lines are spaced apart from each other by a predetermined distance.

17. The display device of claim 1, wherein the display device comprises a flexible display.

18. The display device of claim 1, wherein the controller is further configured to sequentially supply the current to the plurality of scan lines in unit of each frame.

19. The display device of claim 6, wherein touch sensors included in the sensing regions are sequentially turned on in unit of each sensing region.

20. The display device of claim 6, wherein the second sensing region is adjacent to the first sensing region, the third sensing region is adjacent to the second sensing region, and the fourth sensing region is adjacent to the third sensing region.
